(19) United States
(12) Patent Application Publication
(10) Pub. No.: US 2017/0118947 A1
(43) Pub. Date: May 4, 2017

(54) FOLDABLE TRANSPORT BOX

(71) Applicant: Rotho Kunststoff AG, Wurenlingen (CH)

(72) Inventors: Christian Thoma, Albbruck (DE); Markus Brunner, Hilfikon (CH)

(73) Assignee: Rotho Kunststoff AG, Wurenlingen (CH)

(21) Appl. No.: 15/290,603

(22) Filed: Oct. 11, 2016

(30) Foreign Application Priority Data
Oct. 30, 2015 (EP) 15192445.3

(51) Int. Cl. A01K 1/02; A01K 1/035

(52) U.S. Cl. CPC A01K 1/0245; A01K 1/0356

(57) ABSTRACT

A foldable transport box, particularly for transporting small animals, having a bottom, at which two face walls and two side walls made from one or more parts are pivotally mounted. The face walls and the side walls are essentially collapsed onto the bottom in the folded state of the transport box, while in the erected state of the transport box, starting from the bottom, they are essentially erected aligned upwards. The side walls are connected to each other at the top in the erected state of the transport box in order to close the transport box at the top. The side walls are detachably connected to each other at the top of the transport box in the erected state, with at least one side wall being detachable from the face walls and pivotal towards the outside in order to open the transport box in the opened state.

### INCORPORATION BY REFERENCE

The following documents are incorporated herein by reference as if fully set forth: European Patent Application No. 15 192 445.3. filed Oct. 30, 2015.

### BACKGROUND

The invention relates to a foldable transport box, particularly for transporting small animals. A foldable transport box of this type comprises a bottom, two face walls, and two side walls, which are formed from one or more parts. The face walls and the side walls are mounted pivotally at the bottom. In the collapsed state of the transport box the face walls and the side walls are essentially folded onto the bottom, while in the erected state of the transport box, starting from the bottom at which they are pivotally mounted, they are essentially erected oriented upwards. The side walls are connected to each other at their tops in the erected state of the transport box in order to close the transport box at the top. Here, the side walls form a type of pitched roof.

A foldable transport box of the present type is known for example from U.S. Pat. No. 5,493,818. Here the side walls are each embodied in three parts and they are fastened to each other at the top of the transport box with hinges. The individual parts of the side walls are also connected to each other via hinges, so that the side walls themselves can be folded.

In order to bring this transport box of prior art from the erected state into the collapsed state the two face walls are pivoted inwardly and placed onto the bottom. Then the side walls can be collapsed based on their multi-part construction and in this state they can also be placed onto the bottom and the two side walls, respectively.

A door opening is provided in one of the two face walls of this foldable transport box of prior art in which a door is located, mounted pivotally via hinges. By opening said door the interior of the transport box is accessible so that it can be used in the erected state.

Under the aspect of a cost-effective production and with regards to handling being as easy and comfortable as possible this construction of prior art is not optimal, though, due to the high number of hinges and a door that needs to be provided as well.

Another foldable transport box provided for transporting small animals, particularly cats and small dogs, is known from CN 202005193 U. This transport box essentially comprises a stable bottom, which continues at the faces in the form of two soft pliable face walls, as well as a soft pliable cover element, which forms the two side walls This represents therefore a type of travel bag for a small animal, which can be disassembled in a space-saving fashion.

For hygienic reasons it is however desired to provide a transport box for transporting small animals from a material that can be easily cleaned, with here synthetic materials being the first choice due to the requirement for cleaning the material as easily as possible. In order to ensure the required stability, though, it shall not have any soft pliable features.

A transport box for small animals that can be assembled by plugging several parts together is known from U.S. Pat. No. 5,467,734. Although this transport box can be disassembled into several parts in order to allow transporting it in a space-saving condition, however this represents no real foldable transport box in the sense of the present invention, since the disassembly into individual parts as well as the reassembly of the transport box into its assembled state requires the release and/or attachment of many plug-in connections and an appropriate securing and/or releasing thereof.

### SUMMARY

Based on this prior art the objective of the present invention is to improve a foldable transport box of the type mentioned at the outset with regards to production costs as low as possible and uncomplicated handling.

This objective is attained in a foldable transport box having one or more features of the invention. Preferred embodiments of the foldable transport box are discussed below and in the claims.

A foldable transport box according to the present invention comprising a bottom as well as two face walls, mounted pivotally at the bottom, and two side walls, which face walls and side walls in the folded state of the transport box are essentially collapsed on the bottom while in the erected state of the transport box, starting from the bottom, they are essentially erected oriented towards the top, comprises side walls which are detachably connected to each other at the top of the transport box in the erected state, with at least one side wall being detachable from the face walls and pivotal towards the outside in order to open the transport box in the erected state. The access to the interior of the transport box occurs therefore not via a separately provided door but by folding down a side wall.

The fact that no additional door needs to be provided simplifies the construction of the transport box according to the invention. By the ability of folding one of the side walls in the erected state of the transport box it can be easily handled, with it being particularly advantageous that the side wall can be opened completely; because frequently small animals which shall be transported in the transport box must be placed into the transport box against their resistance, which is frequently cumbersome through a face wall or even a door opening inserted therein and which is not an optimal solution, neither for the animal nor for the person.

The folding of the transport box in order to bring it from the erected state into the collapsed state is also considerably facilitated in the construction according to the invention compared to prior art, because the side walls according to the invention are detachably connected to each other at the top of the transport box and thus each side wall and each face wall can be folded separately in order to ultimately fold them down onto the bottom.

The side walls of the transport box according to the invention are preferably provided with detachable connection elements which are particularly equipped as latching connection elements, allowing the side walls in the erected state of the transport box to be connected to each other with the help of detachable connection elements at the top of the transport box.

Particular advantages are provided here when at least one side wall can be fastened also at the bottom in the collapsed state of the transport box using said detachable connection elements. This way it is possible to collapse the face walls and the side walls on the bottom in such a fashion that the side wall, with its detachable connection elements allowing to be fastened at the bottom, can rest on top. By fastening this side wall at the bottom, in cooperation with the hinge via which the side wall is mounted pivotally at the bottom, the collapsed walls and the other side wall folded towards the bottom can be held in this folded state and thus the transport box is secured in its collapsed state. According to the invention the detachable connection elements can therefore secure the foldable transport box both in the erected as well as the folded state which of course simplifies its handling to an enormous extent.

The detachable connection elements which at least connect the side walls at the top of the transport box in the erected state are preferably embodied as pivotal latching element. It is then sufficient that only one of the two side walls has these pivotal latching elements. They can engage behind a respective holding area of the other side wall in order to generate a detachable connection. Optionally these pivotal latching elements can then also be latched in the folded state of the transport box behind respective areas of the bottom in order to secure also the collapsed state of the transport box.

The side wall according to the invention that can be pivoted outwardly is preferably detachably secured in the erected state of the transport box via holding elements provided at least at the one of the two face walls These holding elements can preferably comprise an elastically deformable snap element, which is provided at the respective side wall or the corresponding face wall, engaging an opening of the respective other wall from the inside, thus the face wall or the side wall, and with its engagement being releasable by pressure from the outside. Thus, a type of push button develops which releases a form-fitting connection of the side wall, which is pivotal towards the outside, from the corresponding face wall in order to allow pivoting it towards the outside for opening the erected transport box.

The side walls of the foldable transport box according to the invention are preferably provided with curved edge sections which in the erected state of the transport box are aligned to the face walls. This facilitates not only a connection secured with a snap element between the side walls and the face walls but additionally allows that the face walls in the collapsed state of the transport box can be placed between the bottom and the side walls because the side walls encase by the curved edge sections a respective room between themselves and the bottom.

In order to optimize the compact design of the collapsed state of the transport box according to the invention the side walls can here have different dimensions, so that in the erected state of the transport box the edge sections of one of the two side walls contact the inside of the face walls, while the edge sections of the other of the two side walls contact the outside of the face walls. In the collapsed state then beneficially that side wall is placed last onto the bottom of the transport box which has the greater dimensions so that the face walls are accepted in the space between the bottom and the smaller side wall, while the greater side wall is placed onto the smaller side wall such that the smaller one is accepted together with the face walls contained therein inside the greater side wall. The greater side wall with its edge sections then forms together with the bottom a type of case.

When then additionally latching connection elements are arranged on the top of the greater side wall and they can latch at the bottom, here a compact and safely collapsed condition of the transport box according to the invention results. However, it can still easily be erected and in the erected state can easily be secured without the different dimensions of the two side walls appearing to be asymmetrical in the erected state. This is ensured by the contact of the edge sections of the two side walls with the respective face walls

In addition to a further improved appearance, here the stability of the transport box in its erected state can be optimized such that the face walls are preferably provided with stabilizing elements for inserting the curved edge sections of the side walls

It is particularly preferred for these stabilizing elements to cooperate with projections and/or recesses in the curved edge sections of the side walls in order to compensate forces acting between the bottom and the top of the transport box, for example by appropriate projections engaging the stabilizing elements or vice versa. This way, at least a portion of the forces acting between the top of the transport box and the bottom, when the transport box is carried, are transferred from the side walls to the face walls. The weight force of the erected transport box, particularly when an animal is transported therein, can then be evenly compensated by the face walls and the side walls, even if for example a carrying handle is provided only at the top of the side walls.

Another preferred embodiment of the present invention comprises that the face walls are provided with a latching mechanism which is embodied such that the face walls latch in the upwards oriented, erected state. This facilitates the erection of the foldable transport box.

The bottom of the foldable transport box according to the invention is preferably provided at the bottom with rollers such that it is not required to carry the transport box in the erected state, but it can also be pushed or pulled and thus moved rolling over the ground. Here it is beneficial if the bottom, one face wall, and/or one side wall are provided with an eyelet formed thereat for fastening a strap or a line or the like. Then the transport box according to the invention can be simply pulled on the rollers, with here for example the dog leash being used, which is carried along anyways.

Beneficially, one of the two side walls is provided with a carrying handle at the top of the transport box. This way the transport box can be easily carried both in its erected state as well as its collapsed state, which is of course particularly beneficial if the transport box is not excessively large and the animal transported therein is not very heavy.

Within the scope of the present invention it is preferred for the foldable transport box to be essentially made from plastic by producing the face walls, the side walls, and the bottom from an injection-molded synthetic material. Particularly when using the transport box for transporting small animals, here synthetic material as the material offers particular advantages, since it is robust and can easily be cleaned, while the transport box shows great stability and only minor weight.

Finally, it is preferred within the scope of the present invention for the bottom of the transport box to have a circumferential edge, which is curved upwards, at which the hinges are arranged to connect to the face walls and the side walls This way a type of tub develops, in which for example a soft padding can be inserted for the small animal. Furthermore, an edge of the bottom curved upwards prevents that a small animal, when standing during the transportation, contacts with its paws any of the hinge sections of the face walls and side walls and here potentially becomes injured.

The curved edge allows to provide an essentially bowl-shaped container for water, food, or the like, which is integrated in the transport box or can be separated and inserted, with its height being adjusted to the height of the circumferential edge of the bottom. The latter feature allows to bring the transport box into its collapsed state without requiring to remove the bowl-shaped container or perhaps several bowl-shaped containers out of the transport box.

### BRIEF DESCRIPTION OF THE DRAWINGS

In the following an exemplary embodiment for a foldable transport box designed according to the invention is described and explained in greater detail based on the attached drawings. Shown are:

FIG. 1 an isometric view of a foldable transport box embodied according to the invention in the erected state;

FIG. 2 a detail of FIG. 1;

FIG. 3 the foldable transport box of FIG. 1 in the erected and opened state;

FIG. 4 the foldable transport box of FIG. 1 in the erected and opened state in a different view;

FIG. 5 a detail of FIG. 3;

FIG. 6 the transport box of FIG. 1 in a first phase during the folding process;

FIG. 7 the transport box of FIG. 1 in a second phase during the folding process;

FIG. 8 the transport box of FIG. 1 in a third phase during the folding process;

FIG. 9 the transport box of FIG. 1 in the collapsed state;

FIG. 10 the transport box in the collapsed state in a view diagonally from the bottom;

FIG. 11 a detail of FIG. 9;

FIG. 12 a transport box of FIG. 1 in a view diagonally from the bottom;

FIG. 13 a detail of FIG. 1;

FIG. 14 a detail of FIG. 1 with a variant of the exemplary embodiment shown; and

FIG. 15 a detail of the opened transport box in the variant according to FIG. 14.

### DETAILED DESCRIPTION OF THE PREFERRED EMBODIMENT

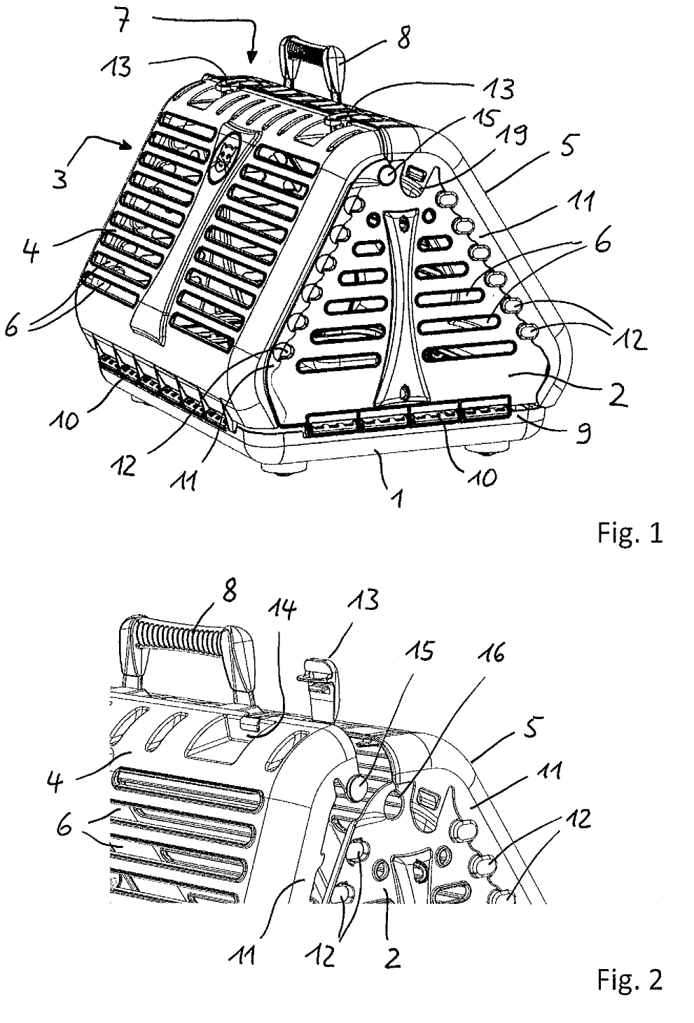

The foldable transport box shown in FIG. 1 in its erected state is assembled from a bottom 1, a first face wall 2, a second face wall 3, a first side wall 4, and a second side wall 5. Both the side walls 2, 3 as well as the side walls 4, 5 are provided with air vents 6 in order to render the transport box suitable for the transportation of small animals, particularly cats. A carrying handle 8 is provided at a top 7, at which the two side walls 4, 5 abut. The bottom 1 comprises a circumferential edge 9, curved upwards, at which hinges 10 are applied for the face walls 2, 3 and the side walls 4, 5. These hinges 10 pivotally fasten both the face walls 2, 3 as well as the side walls 4, 5 at the bottom 1.

The side walls 4, 5 are provided with edge sections 11, which are curved upwards towards the face walls 2, 3. The side walls 4, 5 have different dimensions such that the edge sections 11 of the first side wall 4 contact the face walls 2, 3 from the inside, while the edge sections 11 of the second side wall 5 contact the side walls 2, 3 from the outside. Here, respectively two rows of stabilizing elements 12 are provided at the face walls 2, 3, which form a gap between themselves and the actual face wall 2, 3, into which the edge sections 11 of the side walls 4, 5 can be inserted.

The two side walls 4, 5 are detachably connected to each other at the top 7 of the transport box, namely via two pivotal latch elements 13, which are pivotally fastened at the second side wall 5 and can be fixed in a latching fashion respectively at a holding area 14 at the second side wall 5 (FIG. 2).

According to the invention the transport box shown in the drawing can be opened in the erected state by pivoting open the second side wall 5 in order to place for example a cat into the transport box or to release it therefrom. FIG. 2 shows in a detail which operating elements are provided for this purpose. At first, the two latch elements 13 are released from their engagement at the top 7 by way of pivoting them upwards so that they release the holding areas 14 at the first side wall 4. For reasons of stability the first side wall 4 is fixed at the second side wall 5 not only via the latch elements 13 but also secured via a snap element 15 at the first face wall 2. For this purpose the snap element 15 can be formed at the first side wall 4 in an elastically deformable fashion, and it engages a corresponding opening 16 in the first face from the inside (FIG. 1), such that it can be pushed out of the engagement from the outside by pressing a finger against it, which leads to the situation shown in FIG. 2. Subsequently the first side wall 4 can be pivoted towards the outside.

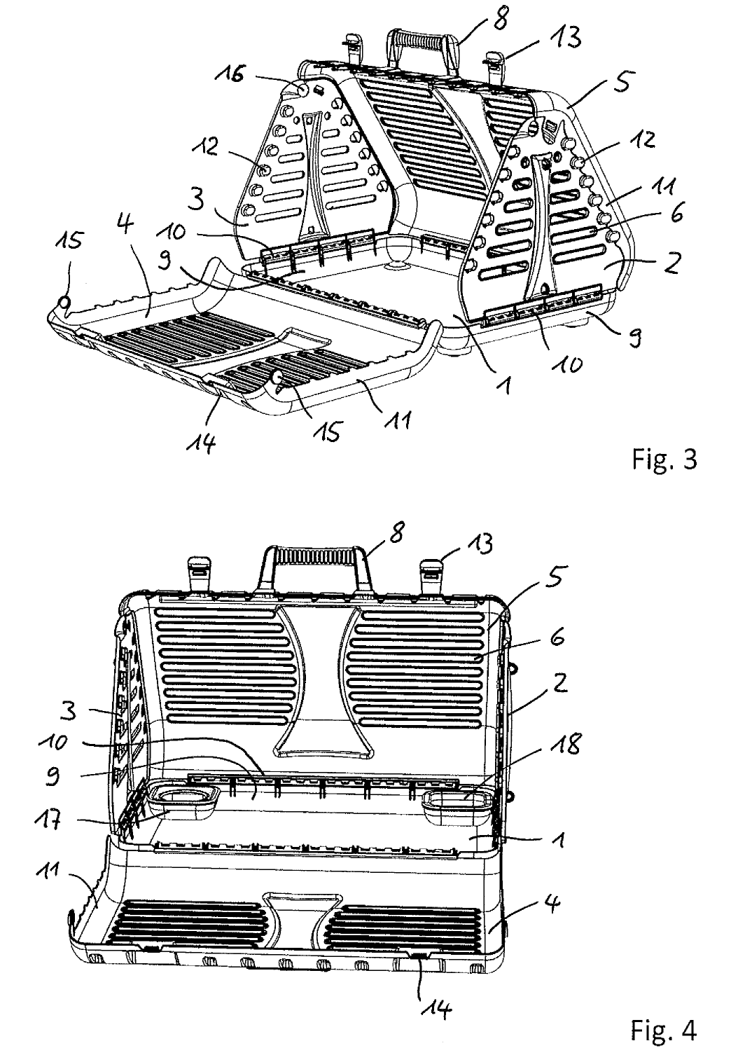

This is shown in FIG. 3: Here the transport box shown in FIG. 1 is opened for putting a cat into it or releasing it therefrom, for example, by pivoting the first side wall 4 completely towards the outside. As discernible from FIG. 3, by pivoting away the first side wall 4 according to the invention a particularly large opening results in order to allow putting for example a cat, which is reluctant to being put into the transport box, comfortably and securely into the box. When pivoting up the first side wall 4 the transport box can then quickly be closed with the two snap elements 15 formed at the first side wall 4 snapping in the first and second face wall 2, 3. By locking the two latch elements 13 the transport box is then secured for transportation in its erected state.

All individual parts of the exemplary embodiment of a foldable transport box shown are made from injection molded synthetic material, such as plastic, which is light-weight, stable, and can be easily cleaned. For the use as a transport box for small animals, here a pad, carpet, or the like can be placed on the bottom. The circumferential edge 9 of the bottom 1 prevents that such an inserted pad or in the worst case scenario even the paws of the animal placed in the box can reach the area of the hinges 10.

FIG. 4 shows the transport box of FIG. 3 in a view rotated about the vertical axis, with a bowl-shaped container 17 for water and a second bowl-shaped container 18 for food being placed on the bottom 1. These two containers 17, 18 are adjusted in their height to the height of the circumferential edge 9 of the bottom 1 such that they can remain in the transport box when it is collapsed.

In the open, erect state as shown in FIGS. 3 and 4 the transport box according to the present exemplary embodiment is however very stable in its shape, because due to the curved edge sections 11 and the stabilizing elements 12 of the second side wall 5 and/or the face walls 2, 3, a form-fitting connection of the face walls 2, 3 and the second side wall 5 remains upheld, with here the connection to the bottom 1 being generated by hinges 10 acting in an additionally stabilizing fashion.

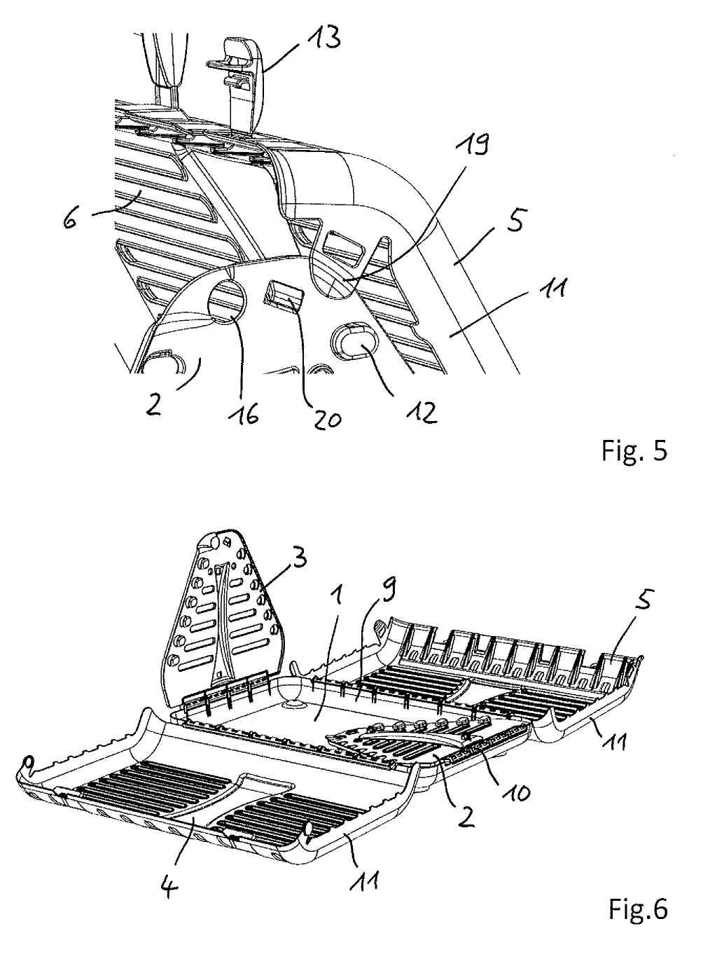

In order to prevent any unintentional pivoting of the second side wall 5 away (from the bottom), here latching flaps 19 are provided, which are formed at the second side wall 5 and with latching hooks 20 engaging them, which are arranged at the face walls 2, 3. By lifting the latching flaps 19 this connection is released so that then the second side wall 5 can also be pivoted away towards the outside, which is shown in FIG. 5.

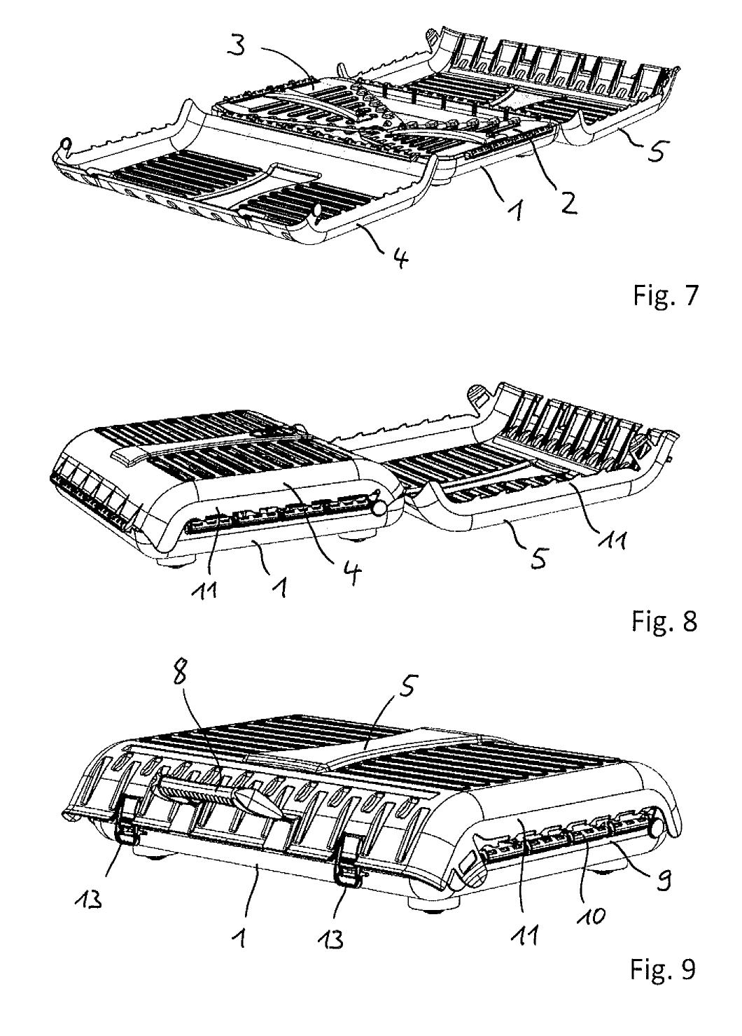

In order to then fold the transport box, initially the first face wall 2, which is now completely released from the side walls 4, 5, is pivoted inwardly towards the bottom 1, as shown in FIG. 6. As discernible from FIG. 7, then the second face wall 3 is also pivoted inwardly and placed onto the bottom 1. Then, as discernible from FIG. 8, the first side wall 4 is pivoted inwardly so that it rests on the bottom 1. Due to the bowl-like shape formed by the curved edge sections 11 the two face walls 2, 3 are received between the first side wall 4 and the bottom 1 such that the first side wall 4 not only contacts the bottom 1 indirectly via the face walls 2, 3, as may be the case within the scope of the invention, but also rests on the hinges 10 of the face walls 2, 3 and thus more directly contacts the bottom 1.

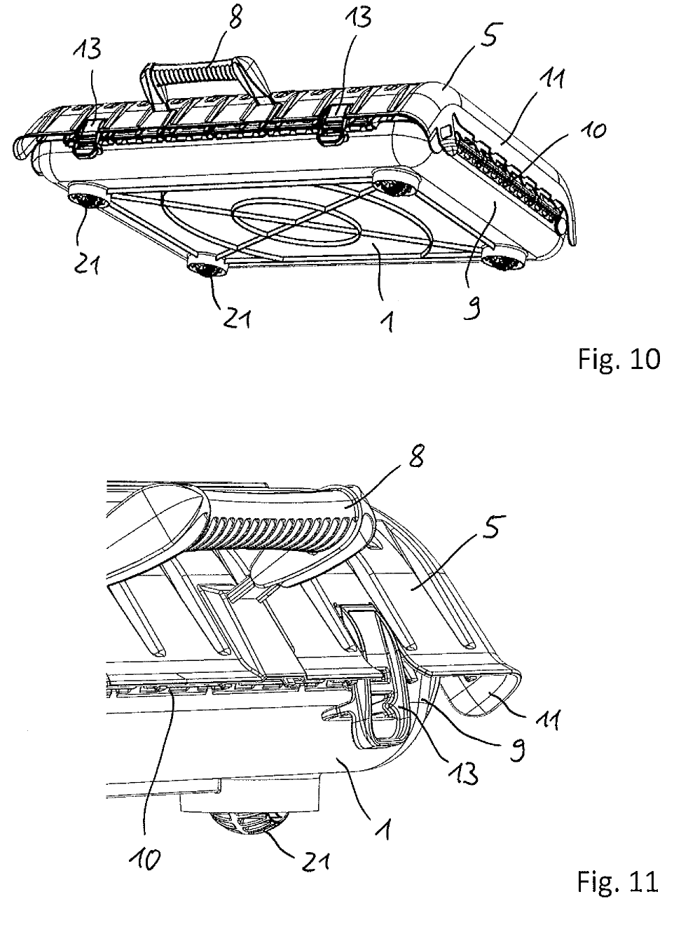

As the last step, which is shown in FIG. 9, finally the second side wall 5 is pivoted inwardly and placed upon the first side wall 4. The second side wall 5 is greater in its dimensions than the first side wall 4 such that the latter can be completely nested inside the first one. The two latch elements 13 arranged at the top of the second side wall 5 can finally be pivoted downwards and latch behind an area formed by the hinge 10 of the first side wall 4 (FIG. 11), so that ultimately the condition of the transport box results shown in FIG. 9. Due to the locking via the latch elements 13 and due to the circumferential edge 9 of the bottom 1 and the curved edge sections 11 of the second side wall 5 this collapsed state is stable and it is shaped similar to a briefcase. The collapsed transport box shown in FIG. 10 can also be carried like a briefcase with the help of a carrying handle 8, which is beneficially provided at the larger, second side wall 5, and stored in a space-saving fashion.

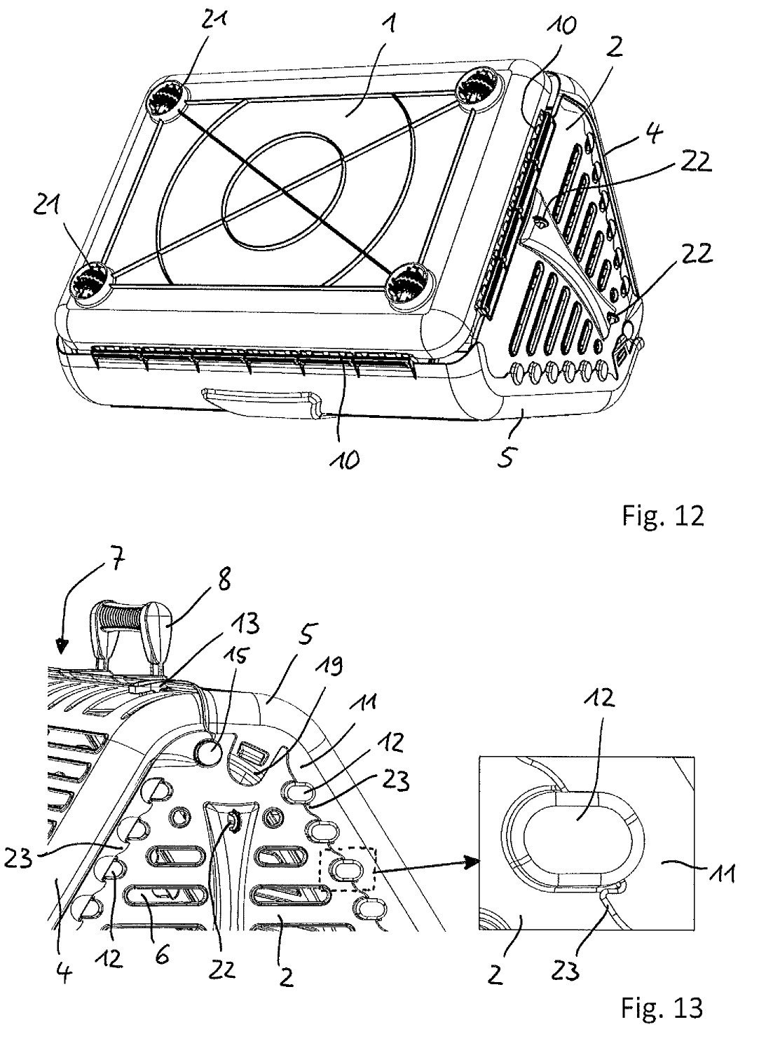

The bottom 1 is discernible from the view shown in FIG. 10 diagonally from the bottom, similarly to FIG. 12. Here it is shown that the bottom 1 is provided with four rollers 21 at the bottom. The transport box can therefore be rolled with rollers over the ground like a suitcase. For this purpose additionally two eyelets 22 are provided at the first face wall 2, in order to allow fastening a leach, for example, at the transport box so that it can be pulled rolling on its rollers 21.

In order to convert the transport box from the collapsed state shown in FIGS. 9 and 10 into the erected state shown in FIG. 1 the phases shown in FIGS. 3, 6, 7, and 8 are processed in the reverse order.

Here, the fact that the face walls 2, 3 during the erection process latch in appropriately shaped hinges 10 in the erected state significantly facilitates the handling.

The present invention therefore represents a very easily handled, foldable transport box, which can be stored in a space-saving and compact fashion and in the erected state can be handled and transported in a stable and user-friendly fashion.

FIG. 13 shows a detail of FIG. 1, with the upper section of the face wall 2 as well as particularly the stabilizing elements 12 and their cooperation with the edge section 11 of the side wall 5 being shown in greater detail. This way it is discernible that the edge section 11 of the side wall 5 is provided with a plurality of projections 23, which engage the stabilizing elements 12 from behind and compensate a portion of the load introduced in the present exemplary embodiment by the carrying handle 8 into the side wall 5 and transmit it via the face wall 2 to the bottom 1.

Respective projections 23 are also discernible in the side wall 4, which cooperate with the stabilizing elements 12 of the face wall 2 located there. This way, the load is evenly distributed to the side walls 4, 5 and the face walls 2, 3, which increases the stability of the transport box overall and releases the latch elements 13.

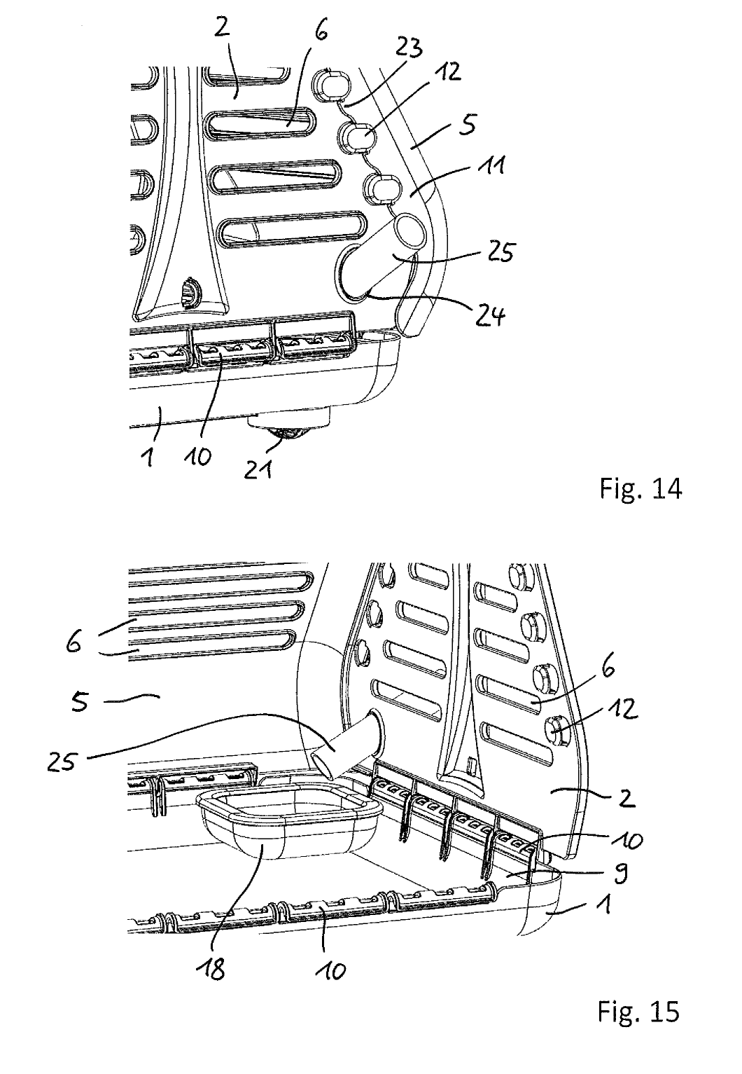

FIG. 14 shows another detail of FIG. 1, however this represents a variant of the exemplary embodiment shown in FIG. 1. This variant is also illustrated in FIG. 15, with it representing here a side view of the opened transport box.

The variant of the present exemplary embodiment shown in FIGS. 14 and 15 of a foldable transport box according to the invention has an opening 24 in the first front wall 2, in which a filling nozzle 25 is inserted. This filling nozzle can be fixed or detachable and, deviating from the present illustration, it may also be equipped with a filling funnel. The purpose of such a filing nozzle 25 is discernible when reviewing FIG. 15, because here it is discernible that the filling nozzle 25 is arranged directly above the bowl-shaped container 18 for food. This container 18 can therefore be refilled from the outside via the fill nozzle 25 without requiring that the transport box is opened. Using the opening 24, an animal located inside the transport box can optionally also be provided with drinking water, namely via the filling nozzle 25 shown in FIGS. 14 and 15 or via special drinking water dispensers that can be applied at the opening 24, for example.

1. A foldable transport box for transporting small animals, comprising:
a bottom (1),
two face walls (2, 3) and two side walls (4, 5) made from one or more parts fastened in a pivotal fashion to the bottom,
wherein in a collapsed state of the transport box the face walls (2, 3) and the side walls (4, 5) are essentially placed together on the bottom (1), and in an erected state of the transport box, starting from the bottom (1), the face walls and the side walls are essentially erected and oriented upwards, and with, in the erected state of the transport box, the side walls (4, 5) being connected to each other at tops (7) thereof in order to close a top of the transport box,
the side walls (4, 5) are detachably connected to each other at the top (7) of the transport box in the erected state, and
at least one of the side walls (4) is detachable from the face walls (2, 3) and outwardly pivotable in order to open the transport box in the erected state.

2. The foldable transport box according to claim 1, further comprising connection elements at the top (7) of the transport box that connect the side walls (4, 5) to each other in the erected state.

3. The foldable transport box according to claim 2, wherein the connection elements comprise latching connection elements (13).

4. The foldable transport box according to claim 2, wherein
in the collapsed state of the transport box at least one of the side walls (5) is fastenable at the bottom (1) using the connection elements (13).

5. The foldable transport box according to claim 1, wherein
in the erected state of the transport box at least the side wall (4) that is outwardly pivotable is detachably secured via holding elements, at least at one of the face walls (2, 3), with holding elements comprising an elastically deformable snap element (15), said snap element engages an opening (16) of the face wall (2, 3) or the side wall (4) from inside and is releasable by pressure applied from outside.

6. The foldable transport box according to claim 1, wherein
the side walls (4, 5) are provided with edge sections (11) curved towards the face walls (2, 3) in the erected state of the transport box.

7. The foldable transport box according to claim 5, wherein
the side walls (4, 5) have different dimensions such that in the erected state of the transport box the edge sections (11) of one of the side walls (4) contact inside of the face walls (2, 3) while the edge sections (11) of the other one of the side walls (5) contact an outside of the face walls (2, 3).

8. The foldable transport box according to claim 7, wherein
the face walls (2, 3) are provided with stabilizing elements (12) to insert the curved edge sections (11) of the side walls (4, 5).

9. The foldable transport box according to claim 8, wherein
the stabilizing elements (12) cooperate with at least one of projections or recesses (23) in curved edge sections (14) in order to compensate forces acting between the bottom (1) and the top (7) of the transport box and at least partially transmitting them from the side walls (4, 5) to the face walls (2, 3).

10. The foldable transport box according to claim 1, wherein
the face walls (2, 3) are provided with a latch mechanism (24) which is embodied such that they latch in an upwards oriented, erected state.

11. The foldable transport box according to claim 1, wherein
the bottom (1) is provided with rollers (21) at an underside thereof.

12. The foldable transport box according to claim 11, wherein
at least one of the bottom (1), one of the face walls (2, 3), or one of the side walls (4, 5) is provided with an eyelet (22) formed thereat for fastening a strap or a line.

13. The foldable transport box according to claim 1, wherein
one of the two side walls (5) is provided with a carrying handle (8) at the top (7) of the transport box.

14. The foldable transport box according to claim 1, wherein
the face walls (2, 3), the side walls (4, 5), and the bottom (1) are made from an injection molded synthetic material.

15. The foldable transport box according to claim 1, wherein
the bottom (1) comprises a circumferential edge (9), curved upwards, with hinges (10) being arranged thereat for a connection between the face walls (2, 3) and the side walls (4, 5).

16. The foldable transport box according to claim 15, further comprising
at least one integrated or separately inserted, essentially bowl-shaped container (17, 18) in the transport box for at least one of water or food, with a height of the container being adjusted to a height of the circumferential edge (9) of the bottom (1).
